(19) United States
(12) Patent Application Publication
(10) Pub. No.: US 2024/0341305 A1
(43) Pub. Date: Oct. 17, 2024

(54) COMPOSITIONS AND METHODS FOR TREATMENT OF A PLANT

(71) Applicants: FITOFORTE SAS, Montevideo (UY); BUZZELET DEVELOPMENT AND TECHNOLOGIES LTD., OR AKIVA (IL)

(72) Inventors: Daniel Noah PLEWINSKI, Meitar (IL); Aharon EYAL, Jerusalem (IL)

(21) Appl. No.: 18/735,243

(22) Filed: Jun. 6, 2024

Related U.S. Application Data
(63) Continuation of application No. PCT/IB2022/061766, filed on Dec. 5, 2022.
(60) Provisional application No. 63/286,116, filed on Dec. 6, 2021.

(51) Int. Cl. A01N 31/16; A01N 25/04; A01N 27/00; A01N 39/00; A01P 3/00; A01P 7/04; A01P 13/02

(52) U.S. Cl. CPC A01N 31/16; A01N 25/04; A01N 27/00; A01N 39/00; A01P 3/00; A01P 7/04; A01P 13/02

(57) ABSTRACT

A method for treating a plant comprising applying a composition comprising at least three active agents selected from the group consisting of carvacrol, thymol, 4-terpineol, alpha-terpinene, alpha-pinene, beta-pinene, d-limonene, azadirachtin, salannin, beta-caryophyllene, menthol, menthone, beta-cymene, 1,8-cineole, verbenone, and cannabidiol (CBD) to at least a portion of the plant.

### CROSS-REFERENCE TO RELATED APPLICATIONS

The present application gains priority from U.S. Provisional Patent Application Ser. No. 63/236,116 filed Dec. 6, 2021, which is incorporated by reference as if fully set-forth herein.

### FIELD OF THE INVENTION

The present invention relates to the field of plant cultivation and more particularly to compositions and methods comprising at least three active agents selected from the group consisting of carvacrol, thymol, 4-terpineol, alpha-terpinene, alpha-pinene, beta-pinene, d-limonene, azadirachtin, salannin, beta-caryophyllene, menthol, menthone, beta-cymene, 1,8-cineole, verbenone, cannabidiol (CBD) and combinations thereof for use in the treatment of plants.

### BACKGROUND OF THE INVENTION

Plants are cultivated on a domestic or industrial scale for many purposes, including the cultivation of flowering plants for aesthetic purposes and cultivation of vegetable plants for human and/or animal consumption.

### SUMMARY OF THE INVENTION

According to an aspect of some embodiments of the present invention, there is provided a method for treating a plant comprising applying a composition comprising at least three active agents selected from the group consisting of carvacrol, thymol, 4-terpineol, alpha-terpinene, alpha-pinene, beta-pinene, d-limonene, azadirachtin, salannin, beta-caryophyllene, menthol, menthone, beta-cymene, 1,8-cineole, verbenone, and cannabidiol (CBD) to at least a portion of the plant.

### BRIEF DESCRIPTION OF THE DRAWINGS

Some embodiments of the invention are described herein with reference to the accompanying figures. The description, together with the figures, makes apparent to a person having ordinary skill in the art how some embodiments of the invention may be practiced.

In the Figures:

FIGS. 1A-D are photographic images of the effects on aphid death after spraying a cannabis plant with an insecticidal composition in accordance with the principles of the present invention, wherein FIG. 1A shows the leaves of the plant prior to spraying; FIG. 1B shows the leaves on day 1 after spraying; and FIG. 1C shows the leaves on day 4, following a second spraying on day 3; and FIG. 1D shows the inflorescence on day 4, following a second spraying on day 3.

FIG. 2A, 2B are photographic images showing aphid death on a cannabis leaf in vitro at day 5 following a single spraying of the leaf with an exemplary composition according to the principles of the present invention (FIG. 1A) and on an untreated leaf as control (FIG. 1B).

### DETAILED DESCRIPTION OF THE INVENTION

The present invention relates to compositions and methods for the treatment of plants.

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

As used herein, the term “terpene” refers to both terpenes and terpenoids, including oxygenated forms such as triterpenoids and tetranortriterpenoids.

As used herein, the term “treating” is intended to refer to altering a condition of a plant, such as preventing, curing, ameliorating, mitigating, and reducing the instances or severity of an undesirable condition of a plant; providing a herbicidal effect, such as preventing or reducing growth of an undesired plant or killing an undesired plant; providing an insecticidal effect to protect a plant against attack by one or more species of insect; and providing a fungicidal effect, such as preventing or reducing growth of a fungus on the plant.

As used herein, the term “applying” includes any method of applying a compound or composition to at least a portion of a plant, such as to a root, stem, bulb, leaf, seed or flower of a plant, or to an entire plant, or applying to soil in which the plant is grown.

According to an aspect of some embodiments of the present invention, there is provided a method for treating a plant comprising applying a composition comprising at least three active agents selected from the group consisting of carvacrol, thymol, 4-terpineol, alpha-terpinene, alpha-pinene, beta-pinene, d-limonene, azadirachtin, salannin, beta-caryophyllene, menthol, menthone, beta-cymene, 1,8-cineole, verbenone and cannabidiol (CBD) and combinations thereof to at least a portion of the plant.

According to some embodiments, the composition comprises three, four, five, or more than five such active agents. According to a preferred embodiment, the composition comprises cannabidiol (CBD).

According to some embodiments, the composition further comprises a surface-active agent. According to some such embodiments, the surface-active agent is selected from the group consisting of polysorbate, sorbitan monooleate, sodium lauryl sulfate, citric acid esters of mono and diglycerides, polyglycerol polyricinoleate and combinations thereof.

According to some embodiments, the composition further comprises an aqueous carrier. According to some embodiments, the carrier is water.

According to some embodiments, the composition is provided in the form of an emulsion.

According to some embodiments, the plant is a cannabis plant or a hemp plant.

According to some embodiments, the plant is a flowering plant.

According to some embodiments, the plant is a vegetable plant. According to some such embodiments, the vegetable is selected from the group consisting of a root vegetable (such as a beet, carrot, radish, sweet potato, turnip), a stem vegetable (such as asparagus and kohlrabi), an edible tuber (such as a potato), a leaf or leafstalk vegetable (such as brussels sprouts, cabbage, celery, lettuce, rhubarb, spinach), a bulb vegetable (such as garlic, leek, onion), a head or flower vegetable (such as artichoke, broccoli and cauliflower) and a seed vegetable (such as a legume, including lentils, beans and peas).

According to some embodiments, the vegetable is selected from the group consisting of cucumber, tomato, eggplant, okra, sweet corn, squash and pepper.

According to some embodiments, the plant is a fruit plant, such as a vine, a bush, or a tree. According to some embodiments, the fruit plant is a vine and the fruit is selected from the group consisting of a grape, a melon, a watermelon, a passionfruit, a kiwi, a strawberry and a dragonfruit.

According to some embodiments, the fruit plant is a bush, and the fruit is selected from the group consisting of a berry (such as a blackberry, a blueberry, a raspberry, a mulberry, a gooseberry), a pineapple, a pawpaw, and a quince.

According to some embodiments, the fruit is selected from a family consisting of Rutaceae (citrus fruits, such as oranges, lemons, limes, grapefruit, tangerines, clementines, pomelos); Cucurbitaceae (gourds, such as squash, pumpkin, zucchini, calabash, watermelon, cucumber, melon, luffa); Prunus (such as plums, cherries, peaches, nectarines, apricots, and almonds); Rosaceae (rose family, such as apples, pears, raspberries, strawberries); and Vitis (such as grapes).

According to some embodiments, treating comprises use as a herbicide against an undesired plant, such as, for example, a plant selected from the group consisting of Chenopodium album (also known as wild spinach); Portulaca oleracea (also known as duckweed); and Echinochloa crus-galli (also known as cockspur grass).

According to some such embodiments, the composition comprises carvacrol, alpha-terpineol and beta-pinene.

According to some embodiments of the use as a herbicide, the composition further comprises at least one, at least two, at least three, or all four compounds selected from the group consisting of thymol, 4-terpineol, alpha-pinene, and d-limonene. According to some such embodiments, the composition comprises 20-40% wt carvacrol, 3-20% wt alpha-terpineol and 3-20% wt beta-pinene. According to some embodiments, the composition comprises 10-30% wt thymol.

According to some embodiments, treating comprises providing an insecticidal effect, such as against an insect selected from the group consisting of thrips, aphids, lice, shield bugs, butterflies and moths.

According to some embodiments, the insecticidal composition comprises at least three, such as three, four or all five compounds selected from the group consisting of terpineol, limonene, caryophyllene, menthone and menthol.

According to some embodiments of the insecticidal composition, terpineol is present at a concentration of from about 10 to about 20% wt. According to some embodiments, limonene is present at a concentration of from about 5 to about 15% wt. According to some embodiments, caryophyllene is present at a concentration of from about 2 to about 10% wt. According to some embodiments, menthone is present at a concentration of from about 2 to about 10% wt. According to some embodiments, menthol is present at a concentration of from about 2 to about 10% wt.

According to some embodiments, the insecticidal composition further comprises at least one selected from the group consisting of thymol, azadirachtin, salannin, carvacrol and CBD.

According to some embodiments of the insecticidal composition, thymol is present at a concentration of from about 15 to about 50% wt. According to some embodiments, carvacrol is present at a concentration of from about 10 to about 30% wt. According to some embodiments, CBD is present at a concentration of from about 2 to about 10% wt.

According to some embodiments, treating comprises providing a fungicidal effect, such as against a fungus selected from the group consisting of Cladosporium, Aspergillus and Phaeosphaericease. According to some such embodiments, the composition comprises carvacrol, thymol and 4-terpineol. According to some such embodiments, the composition further comprises at least one, at least two or all three compounds selected from the group consisting of beta-cymene, 1,8-cineole and verbenone. According to some such embodiments, the composition comprises 30-50% wt carvacrol, 30-50% wt thymol and 1-10% 4-terpineol.

According to some embodiments, the composition is provided in the form of a concentrated stock composition, wherein treating comprises diluting the concentrated stock composition to form a diluted composition comprising a total active agent concentration of between about 0.1% wt and about 10.0% wt, such as about 0.1 wt %, about 0.5 wt %, about 1 wt %, about 2 wt %, about 3 wt %, about 4 wt %, about 5 wt %, about 6 wt %, about 7 wt %, about 8 wt %, about 9 wt % or about 10 wt % and applying the diluted composition to said plant.

According to some embodiments, applying comprises spraying, preferably to at least a portion of a pre-emergent plant.

According to some embodiments, the composition is applied twice. According to some such embodiments, a second application is performed between 7 and 14 days after a first application of said composition, such as at day 7, 8, 9, 10, 11, 12, 13 or 14 after the first application.

According to some embodiments, between 20 and 400 liter of the diluted composition is applied per 1000 sq meters of treated land area.

### EXAMPLES

Presented below are exemplary compositions according to the principles of the present invention.

### Example 1: Herbicidal Compositions

TABLE 1
Herbicide

| Name | CAS | % |
|---|---|---|
| Carvacrol | 499-75-2 | 30 |
| Thymol | 89-83-8 | 20 |
| 4-Terpineol | 562-74-3 | 10 |
| α-Terpinene | 99-86-5 | 10 |
| α-Pinene | 80-56-8 | 10 |
| β-Pinene | 127-91-3 | 10 |
| d-Limonene | 5989-27-5 | 10 |

### Example 2: Insecticidal Compositions

TABLE 2
Insecticide

| | | |
|---|---|---|
| Name | CAS | % |

| | | | | | |
|---|---|---|---|---|---|
| Thymol | 89-83-8 | | 20 | 20 | 40 |
| Azadirachtin | 11141-17-6 | 40 | 40 | 40 | |
| Salannin | 992-20-1 | 20 | | | |
| Carvacrol | 499-75-2 | | | | 20 |
| 4-Terpineol | 562-74-3 | 15 | 15 | 15 | 15 |
| d-Limonene | 5989-27-5 | 10 | 10 | 10 | 10 |
| β-Caryophyllene | 87-44-5 | 5 | 5 | 5 | 5 |
| Menthol | 1490-04-6 | 5 | 5 | 5 | 5 |
| Menthone | 14073-97-3 | 5 | 5 | 5 | 5 |
| CBD | 13956-29-1 | | | 5 | 3 |

### Example 3: Fungicidal Compositions

TABLE 3
Fungicide

| Name | CAS | % |
|---|---|---|
| Carvacrol | 499-75-2 | 40 |
| Thymol | 89-83-8 | 40 |
| 4-Terpineol | 562-74-3 | 5 |
| p-Cymene | 99-87-6 | 5 |
| 1,8-Cineole | 470-82-6 | 5 |
| Verbenone | 80-57-9 | 5 |

### Example 4: Effect of an Exemplary Composition on Cannabis Plants

A concentrated composition (reference name BZT4) as presented in Table 4, was prepared, comprising combinations of selected terpenes (thymol, carvacrol, terpineol, limonene, caryophyllene, menthone and menthol) at various concentrations and CBD.

The concentrated composition was diluted with tap water to provide a stock composition comprising a total of 40 wt % active agents (terpenes plus CBD) and 60 wt % water, at weights shown in Table 5. Prior to use, the stock composition was further diluted to a final composition comprising a total of 2 wt % active ingredients in water.

TABLE 4

| | |
|---|---|
| Thymol | 40% |
| Carvacrol | 20% |
| Terpineol | 15% |
| Limonene | 10% |
| Caryophyllene | 5% |
| Menthone | 5% |
| Menthol | 5% |
| CBD | 5% |

TABLE 5

| | | |
|---|---|---|
| Thymol | 80 | gr |
| Carvacrol | 40 | gr |
| Terpineol | 30 | gr |
| Limonene | 20 | gr |
| Caryophyllene | 10 | gr |
| Menthone | 10 | gr |
| Menthol | 10 | gr |
| CBD | 10 | gr |
| Water | 300 | gr |

About 40 ml of the diluted composition was sprayed onto the leaves of each of 5 test cannabis plants during growth on a cannabis farm. Spraying was carried out twice, with an interval of 3 days between successive sprayings. Untreated plants served as control.

The leaves of each plant were examined daily for the viability of aphids and the overall condition of the plant and the results recorded.

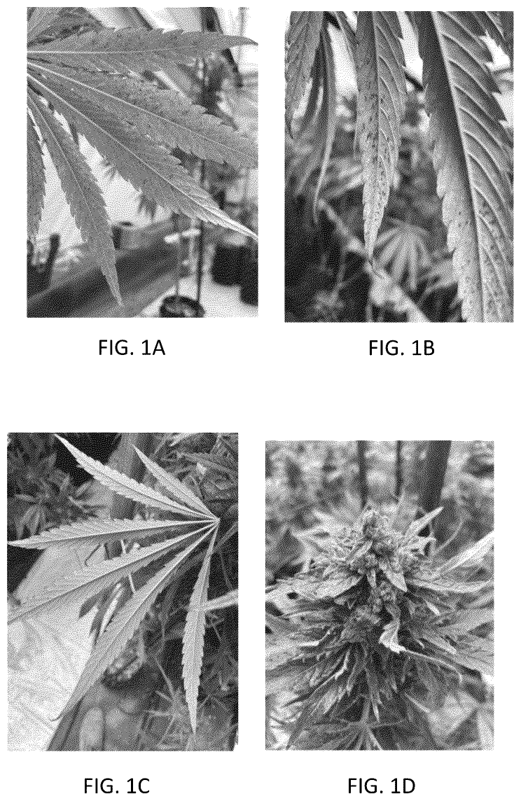

As shown in FIG. 1A, prior to spraying, most aphids on the cannabis leaves were of a green color. From day 1 after spraying, as shown in FIG. 1B, aphids color was seen to have turned to brown-black, indicating aphid death. A second spraying was carried out on day 3 and the leaves were further examined one day later (i.e. on day 4). As shown in FIG. 1C, on day 4 at about 90% of aphids were found to be dead.

### In Vitro Testing of the Effects of Exemplary Compositions

A single cannabis leaf was placed in each of ten 84 mm tissue culture dishes. The base of the dishes were covered with an agar layer to maintain freshness of the leaf. 10 aphids were placed on top of each leaf. Five of the dishes were sprayed with composition BZT4 at a concentration of 3.5 wt % using a conventional potter spray tower. The number of aphid deaths occurring per day was closely monitored and counted over the next 5 days. The remaining five dishes were sprayed with water alone to serve as controls.

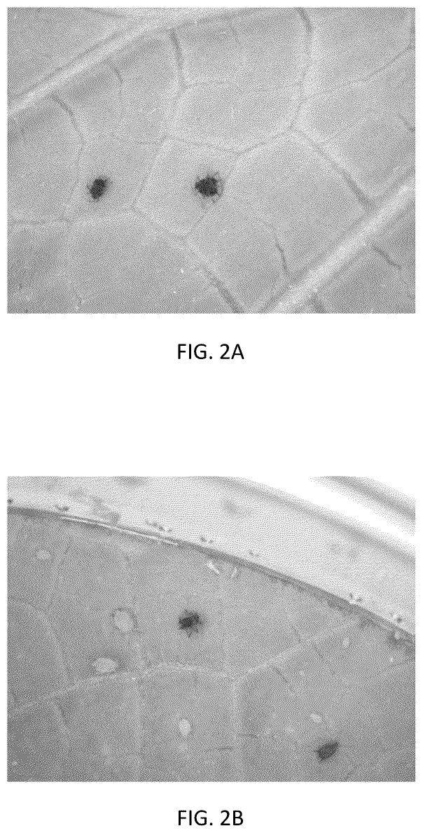

The results as presented in Table 6 and shown in FIG. 2A demonstrate 86% death at day 5 in dishes treated with composition BZT4, while only 24% death was seen at day 5 in the control dishes, as shown in FIG. 2B, which is probably due to natural death due to aging. As further shown in Table 6, natural death appears to start at day 3 to day 5 in the control dishes. In contrast, death occurred already at day 1 in the test dishes sprayed with the composition and reached a peak at day 3. Following day 3, natural death might also contribute to overall death in the treated dishes.

TABLE 6

| | | | | | |
|---|---|---|---|---|---|
| Dish | 1 | 2 | 3 | 4 | 5 |

Test composition - number of deaths

| | | | | | |
|---|---|---|---|---|---|
| Day 1 | 3 | 0 | 1 | 1 | 3 |
| Day 2 | 6 | 5 | 5 | 2 | 3 |
| Day 3 | 8 | 7 | 8 | 7 | 8 |
| Day 4 | 9 | 7 | 9 | 7 | 6 |
| Day 5 | 10 | 10 | 9 | 7 | 7 |

Control - number of deaths

| | | | | | |
|---|---|---|---|---|---|
| Day 1 | 0 | 0 | 0 | 0 | 0 |
| 0ay 2 | 0 | 0 | 1 | 0 | 0 |
| Day 3 | 1 | 1 | 1 | 0 | 2 |
| Day 4 | 3 | 1 | 3 | 2 | 2 |
| Day 5 | 3 | 1 | 3 | 2 | 3 |

What is claimed is:

1. A method for treating a plant comprising applying a composition comprising at least three active agents selected from the group consisting of carvacrol, thymol, 4-terpineol, alpha-terpinene, alpha-pinene, beta-pinene, d-limonene, azadirachtin, salannin, beta-caryophyllene, menthol, menthone, beta-cymene, 1,8-cineole, verbenone, and cannabidiol (CBD) to at least a portion of the plant.

2. The method of claim 1, wherein said composition comprises cannabidiol (CBD).

3. The method of claim 1, wherein said composition further comprises a surface-active agent.

4. The method of claim 1, wherein said plant is selected from the group consisting of a cannabis plant, a hemp plant, a vegetable plant, a flowering plant and a fruit plant.

5. The method of claim 1, wherein said treating comprises providing a herbicidal effect against an undesired plant and wherein said composition comprises carvacrol, alpha-terpineol and beta-pinene.

6. The method of claim 5, wherein said composition further comprises at least one selected from the group consisting of thymol, 4-terpineol, alpha-pinene, and d-limonene.

7. The method of claim 5, wherein said composition comprises 20-40% wt carvacrol, 3-20% wt alpha-terpineol and 3-20% wt beta-pinene.

8. The method of claim 6, wherein said composition comprises 10-30% wt thymol.

9. The method of claim 1, wherein said treating comprises providing an insecticidal effect and wherein said composition comprises at least three selected from the group consisting of terpineol, limonene, caryophyllene, menthone and menthol.

10. The method of claim 9, wherein said composition further comprises at least one selected from the group consisting of thymol, azadirachtin, salannin, carvacrol and CBD.

11. The method of claim 9, wherein said composition comprises thymol, carvacrol, terpineol, limonene, caryophyllene, menthone, menthol and CBD.

12. The method of claim 1, wherein said treating comprises providing a fungicidal effect and wherein said composition comprises carvacrol, thymol and 4-terpineol.

13. The method of claim 12, wherein said composition further comprises at least one selected from the group consisting of beta-cymene, 1,8-cineole and verbenone.

14. The method of claim 12, wherein said composition comprises 30-50% wt carvacrol, 30-50% wt thymol and 1-10% 4-terpineol.

15. The method of claim 1, wherein said composition further comprises an aqueous carrier.

16. The method of claim 3, wherein said surface-active agent is selected from the group consisting of polysorbate, sorbitan monooleate, sodium lauryl sulfate, citric acid esters of mono and diglycerides, polyglycerol polyricinoleate and combinations thereof.

17. The method of claim 1, wherein said composition is provided in the form of an emulsion.

18. The method of claim 1, wherein said treating comprises diluting said composition to form a diluted composition comprising a total active agent concentration of between 0.1% wt and 10.0% wt and applying said diluted composition to said plant.

19. The method of claim 1, wherein said applying comprises spraying.

20. The method of claim 1, wherein applying of said composition is performed twice.

21. The method of claim 20, wherein said second a second application of said composition is performed between 7 and 14 days after a first application of said composition.

22. The method of claim 18, wherein said applying comprises applying between 20 and 400 liter of said diluted composition per 1000 sq meters treated land area.
